(19) United States
(12) Patent Application Publication
(10) Pub. No.: US 2023/0345856 A1
(43) Pub. Date: Nov. 2, 2023

(54) METHOD AND SYSTEM FOR MONITORING AUTONOMOUS AGRICULTURAL PRODUCTION MACHINES

(71) Applicant: CLAAS E-Systems GmbH, Dissen a.T.W. (DE)

(72) Inventors: Reinhold Mähler, Rheda-Wiedenbrück (DE); Christian Ehlert, Bielefeld (DE); Bastian Bormann, Gütersloh (DE); Joachim Baumgarten, Beelen (DE); Dennis Neitemeier, Lippetal (DE); Johann Witte, Fröndenberg (DE); Jannik Redenius, Oldendorf (DE); Arne Bohl, Gütersloh (DE); Eberhard Nacke, Gütersloh (DE); Christoph Apke, Bielefeld (DE); Timo Korthals, Leopoldshöhe (DE); Waldemar Thiesmann, Osnabrück (DE); Axel Schröder, Gütersloh (DE); Robin Monkenbusch, Rheda-Wiedenbrück (DE)

(73) Assignee: CLAAS E-Systems GmbH, Dissen a.T.W. (DE)

(21) Appl. No.: 18/139,528

(22) Filed: Apr. 26, 2023

(30) Foreign Application Priority Data
Apr. 27, 2022 (DE) 10 2022 110 213.0

(51) Int. Cl. A01B 76/00

(52) U.S. Cl. CPC A01B 76/00

(57) ABSTRACT

A method for monitoring autonomous agricultural production machines is disclosed. The autonomous agricultural production machine autonomously performs an agricultural job. When an anomaly occurs, the autonomous agricultural production machine performs a response routine, interrupting the performance of the agricultural job. The autonomous agricultural production machine senses anomaly data during and/or after the response routine and transmits the anomaly data to a remote monitoring center in a reporting routine that a user may access in the remote monitoring center. The remote monitoring center generates, based on the anomaly data, a control instruction and transmits the control instruction to the autonomous agricultural production machine to execute in order to further respond to the anomaly and thereafter continue to perform the agricultural job.

### CROSS REFERENCE TO RELATED APPLICATION

This application claims priority under 35 U.S.C. § 119 to German Patent Application No. DE 10 2022 110 213.0 filed Apr. 27, 2022, the entire disclosure of which is hereby incorporated by reference herein. This application incorporates by reference herein the following US applications in their entirety: U.S. application Ser. No. ______ entitled “AUTONOMOUS AGRICULTURAL PRODUCTION MACHINE” (attorney docket no. 15191-23004A (P05575/8)); U.S. application Ser. No. ______ entitled “SWARM ASSISTANCE SYSTEM AND METHOD FOR AUTONOMOUS AGRICULTURAL UNIVERSAL PRODUCTION MACHINES” (attorney docket no. 15191-23005A (P05576/8)); U.S. application Ser. No. ______ entitled “METHOD AND SYSTEM FOR MONITORING OPERATION OF AN AUTONOMOUS AGRICULTURAL PRODUCTION MACHINE” (attorney docket no. 15191-23007A (P05580/8)); and U.S. application Ser. No. ______ entitled “SYSTEM AND METHOD FOR DEPLOYMENT PLANNING AND COORDINATION OF A VEHICLE FLEET” (attorney docket no. 15191-23008A (P05585/8)).

### TECHNICAL FIELD

The present application relates to a method for monitoring autonomous agricultural production machines, to an autonomous agricultural production machine, and to a use of an autonomous agricultural production machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Autonomous agricultural production machines, such as autonomous combine harvesters, autonomous forage harvesters, autonomous tractors, and autonomous agricultural universal production machines, may perform various agricultural tasks automatically.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates the performance of an agricultural job.

FIG. 2 illustrates the remote monitoring center in operation.

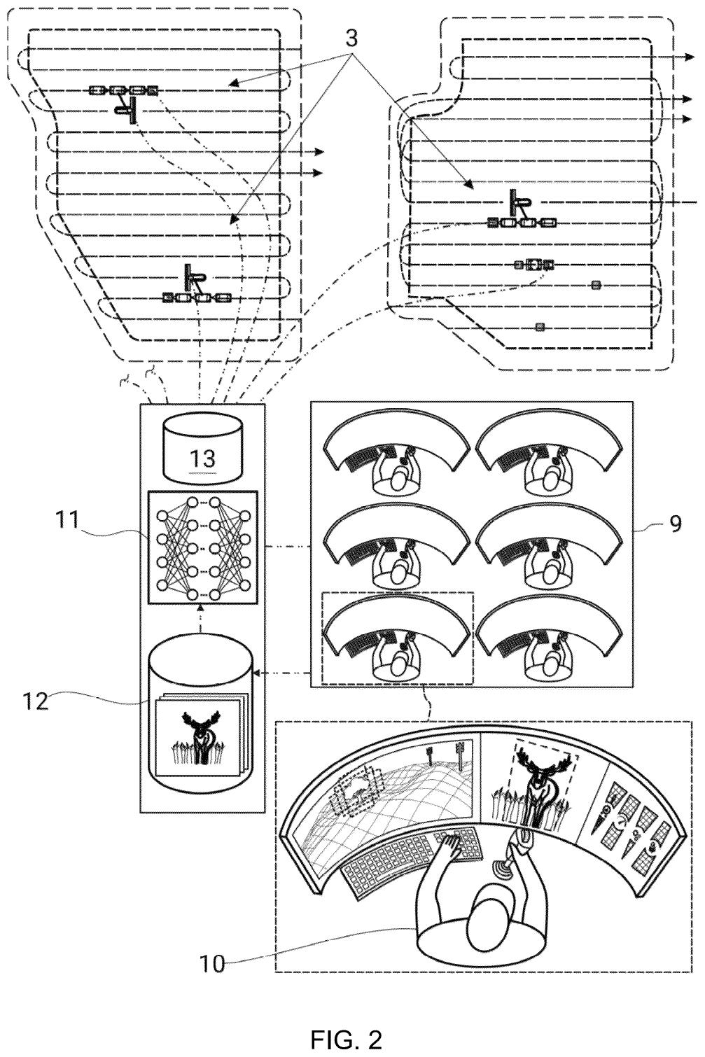

FIG. 3 illustrates two autonomous agricultural universal production machines working together as forage harvesters.

### DETAILED DESCRIPTION

As discussed in the background, autonomous agricultural production machines, such as any one, any combination, or all of autonomous combine harvesters, autonomous forage harvesters, autonomous tractors, and autonomous agricultural universal production machines, may perform various actions automatically. Thus, in one or some embodiments, any discussion herein regarding autonomous may comprise automatic operation without any human intervention. However, the autonomous agricultural production machines may face common challenges and perform agricultural tasks largely on their own. Problematically, the autonomous agricultural production machines may not be able to continue their work in all unexpected situations. Also, in some expected situations, the only available or viable option may be to automatically stop the autonomous agricultural production machine. This may result in a user having to monitor the autonomous agricultural production machine for automatic stoppage. In this regard, one of the main advantages of an autonomous agricultural production machine, in particular its autonomy and its completely automatic operational nature, may not then be fully realized.

Thus, in principle, approaches for monitoring or remotely controlling autonomous agricultural production machines are known, but suffer from problems that still leave much potential open in terms of results. It is therefore a challenge to optimize autonomous agricultural production machines in terms of their autonomy.

One consideration is that an autonomous agricultural production machine usually has enough sensors to allow a remote monitoring center to decide how to respond to an anomaly based only on the sensor data. It may therefore be sufficient for an autonomous agricultural production machine to automatically initiate a response routine when an anomaly is present, and then outsource the decision on how to proceed further to a user or a more powerful artificial intelligence (AI) that does not need to be on site. Therefore, a remote monitoring center is disclosed to which the autonomous agricultural production machine transmits sensor data on an anomaly, and from which a control instruction is generated on how the autonomous agricultural production machine should proceed further.

Specifically, in one or some embodiments, the autonomous agricultural production machine is configured to sense an anomaly (e.g., sense anomaly data indicative of the anomaly) during and/or after the response routine, and is configured to transmit the anomaly data to a remote monitoring center in a reporting routine. In response to the transmission, the remote monitoring center is configured to generate, based on the anomaly data, a control instruction and transmit the control instruction to the autonomous agricultural production machine in order for the autonomous agricultural production machine to address the anomaly. In response to receiving the control instruction, the autonomous agricultural production machine is configured to execute the control instruction, and then continue to perform the agricultural job.

In one or some embodiments, the monitoring may be activated as a service using the remote monitoring center. In this way, this may be a simple way to offer or make use of the remote monitoring as needed.

In one or some embodiments, the autonomous agricultural production machine is configured to perform an emergency stop in the response routine, and/or that an anomaly is indicative of an obstacle (to which the autonomous agricultural production machine responds with performing an emergency stop). Obstacles may be the most common and dangerous anomalies that may occur when performing an agricultural job using an autonomous agricultural production machine. Given the monitoring by the remote monitoring center, an emergency stop may be an acceptable emergency solution in almost every case since the remote monitoring center may decide then how or whether to continue the agricultural job. It is therefore unproblematic when, if necessary, an emergency stop is performed more frequently than may be necessary.

One embodiment concerns two options for how the remote monitoring center may proceed in interaction with the autonomous agricultural production machine. On the one hand, it is contemplated for a routine (such as the response routine) that is to be executed to already be saved in the autonomous agricultural production machine, and it only has to be selected and accessed from memory, whereby little data need be transmitted; on the other hand, it is also contemplated that the autonomous agricultural production machine is remotely controlled using the remote monitoring center. In this regard, the routine (such as the response routine) need not be resident within the autonomous agricultural production machine in order for the routine to control the autonomous agricultural production machine.

In one or some embodiments, the remote monitoring center is configured to monitor a plurality of autonomous agricultural production machines. In this way, simple and efficient monitoring of many autonomous agricultural production machines may be achieved.

In one or some embodiments, an AI model, through which the autonomous agricultural production machines may be controlled, may be re-trained by linking the anomaly data and the control instructions of the remote monitoring center in response to the anomalies. In this way, the AI model (and in turn the autonomous agricultural production machines controlled by the AI model) may be successively improved based on real data.

In one or some embodiments, a distinction may be made between two concepts of autonomous agricultural machines. On the one hand, autonomous agricultural machines may be specialized, such as an autonomous combine harvester or even an autonomous wheat combine harvester, or the autonomous agricultural machines may be generalized. Thus, in one embodiment, generalized autonomous agricultural production machines comprise autonomous agricultural universal production machines. These autonomous universal agricultural production machines may be distinguished by the fact that they may be used for a variety of different agricultural jobs by changing configurations such as changing work assemblies and changing software modules.

In particular, such autonomous universal agricultural production machines may have decisive advantages in terms of their capacity and purchase costs, but may have the disadvantage that they are technically more demanding, especially in terms of software. An AI model that is trained to always harvest only wheat with the same technical equipment may be technically easier to realize or to train than an AI model that may perform any agricultural job with any equipment. Therefore, the amount of anomalies in the sense of states or measured values that were unexpected may also be disproportionately greater in an autonomous agricultural universal production machine than in an autonomous production machine that may be precisely or specifically adapted to its particular activity. Therefore, the need for remote monitoring may also be greater for autonomous agricultural universal production machines, which may make the disclosed solution particularly advantageous in this case.

In one or some embodiments, various types of the anomaly data are contemplated. In one or some embodiments, provision may be made for the user in the remote monitoring center to access additional data from a database beyond or separate from the anomaly data. This database may include general background information such as field information data or weather data. In particular, the database may include data that are not accessible to the autonomous agricultural production machine.

In one or some embodiments, the autonomous agricultural production machine is configured to continuously send data to the remote monitoring center. The term “continuous” or “continuously” may generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process. Therefore, in the event of an anomaly, the user in the remote monitoring center may directly access a large amount of current and historical data. Furthermore, monitoring of the autonomous agricultural production machine is also made possible on an ad hoc basis, for example on a random or regular basis. Alternatively, it may be provided that the autonomous agricultural production machine only sends data to the remote monitoring center after it has triggered the response routine. In this way, data traffic may be kept to a minimum.

In one or some embodiments, unless the anomaly may be resolved remotely, a service technician may be dispatched.

In one or some embodiments, in the event of an anomaly, at least one further agricultural production machine of a network of agricultural production machines in which the autonomous agricultural production machine is operating is configured to transmit environment sensor data to the remote monitoring center that depicts or characterizes the autonomous agricultural production machine and/or the immediate environment. This may allow the user in the remote monitoring center to get a wider view of an obstacle, for example.

In one or some embodiments, the remote monitoring center may monitor broader activities besides the agricultural job, and therefore may generally monitor the use of the autonomous agricultural production machine and, in turn, ensure that the autonomous agricultural production machine is performing its work.

In one or some embodiments, an autonomous agricultural production machine is claimed to be configured for use in the disclosed method. Reference is made to all statements regarding the disclosed method.

In one or some embodiments, a use of an autonomous agricultural production machine in the disclosed method. Reference is made to the disclosed method, and the disclosed autonomous agricultural production machine.

In one or some embodiments, an exemplary application is a harvesting process. This harvesting process may comprise, for example, the process chain of one or both of the agricultural jobs “harvesting a crop” and “salvaging the crop”.

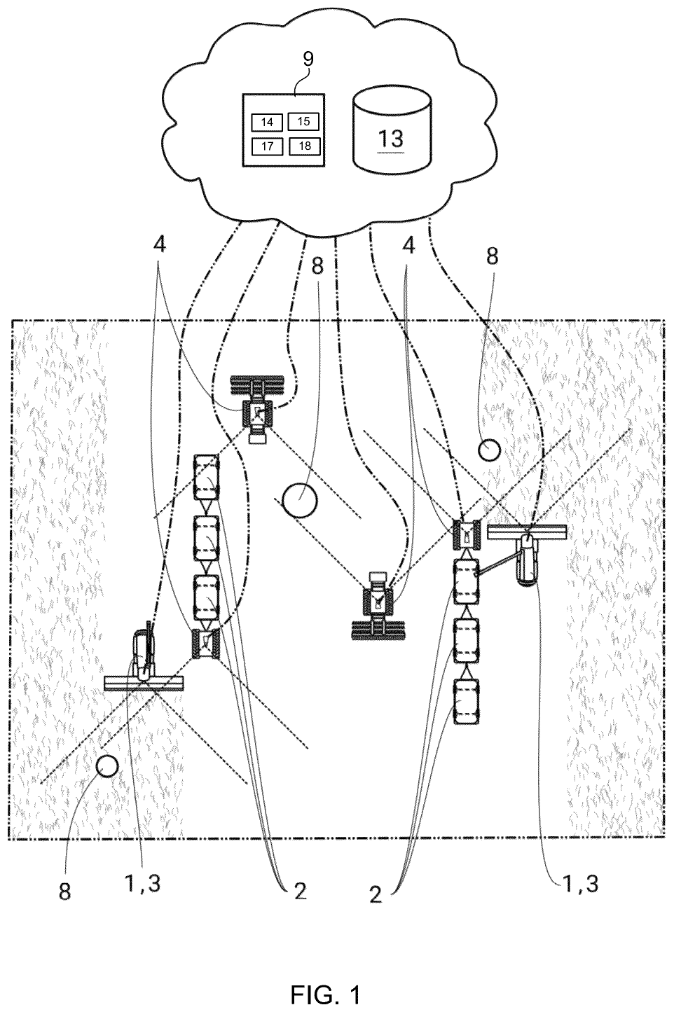

As a rule, this process chain may be executed in such a way that one or more agricultural production machines designed as combine harvesters 1 first harvest the crop grown on a cultivated area (see FIG. 1). As an example, the part of the harvested material formed by the fruit may be temporarily stored in a grain tank on the combine harvester 1 while the remaining part of the harvested material (e.g., the straw) may be deposited in windrows on the cultivated area. When the straw deposited in windrows has reached a moisture content that allows the straw to be stored, a baler pulled by a tractor may compress the straw into bales of the harvested material that are first deposited on the cultivated area.

In another step of the process chain, the harvested material bales may be loaded by so-called lift trucks onto platform trailers towed by tractors, for example, and transported away for storage. Similarly, the fruit temporarily stored in the grain tank may be taken by tractor-drawn transport trailers and sent to storage or further processing.

In the present case, one or more of these activities may now be performed by autonomous agricultural production machines 3, such as autonomous agricultural universal production machines 4 in various configurations. FIG. 1 shows, for example, cooperation between four autonomous agricultural universal production machines 4 and two autonomous combine harvesters 1 during harvesting.

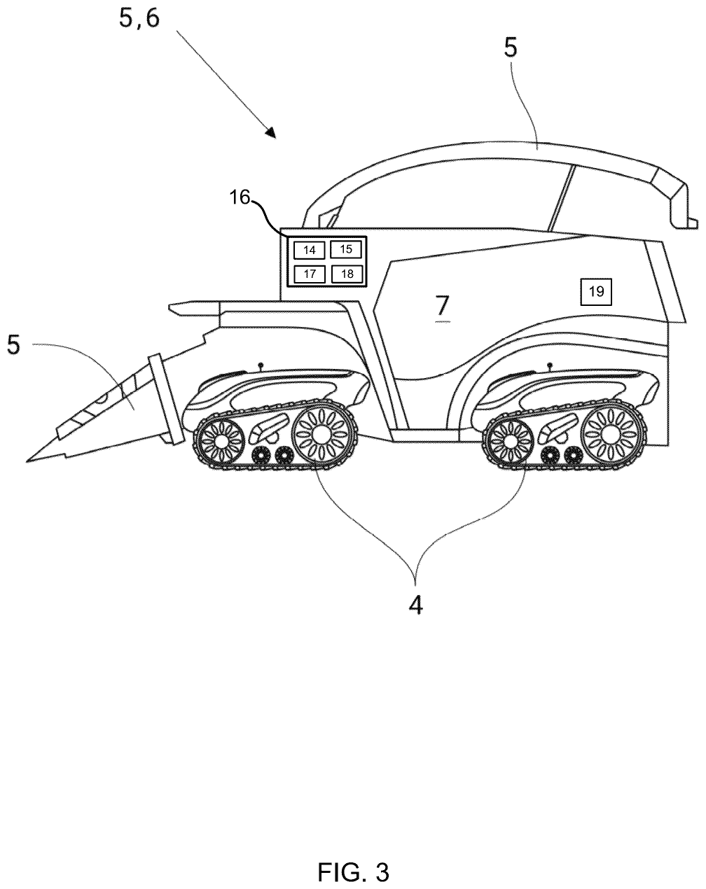

Alternatively, it is also contemplated that the autonomous agricultural universal production machines 4 are used as a forage harvester 6 via configuration changes (e.g., by equipping them with corresponding work assemblies 5). It is contemplated, for example, that a rudimentary forage harvester 7 may be operated as a work assembly 5 with little electronics and no traction drive by means of one or more autonomous agricultural universal production machines 4, in that the autonomous agricultural universal production machines 4 may serve as a traction drive and control and may be docked to the rudimentary forage harvester 7 (see FIG. 3). The rudimentary forage harvester 7 may have computing functionality 16, which may include at least one processor 14, at least one memory 15, a user interface 17 (e.g., a touchscreen), and a communication interface 18. Communication interface 18 may be configured to communicate (e.g., wired and/or wirelessly) with one or more other external electronic devices, such as remote monitoring center 9. Further, the rudimentary forage harvester 7 may include one or more sensors 19 in which to sense various aspects of its operation and/or of its environment (e.g., to sense one or more obstacles), as discussed herein.

A method for monitoring autonomous agricultural production machines 3 is disclosed, wherein the autonomous agricultural production machine 3 may autonomously or automatically perform an agricultural job, wherein when an anomaly occurs, the autonomous agricultural production machine 3 is configured to perform a response routine, and wherein the autonomous agricultural production machine 3 is configured to respond to the anomaly in the response routine and to interrupt the performance of the agricultural job.

As will be explained further below, the response routine may include an emergency stop of the autonomous agricultural universal production machine 4 and may additionally or alternatively include changing work assemblies 5 to a safe state. For example, if an autonomous agricultural universal production machine 4 towing a transport trailer 2 encounters an obstacle 8, it may simply automatically stop. However, the problem is that it may regularly lack the capabilities to safely maneuver relatively unknown transport trailers 2 around the obstacle 8 or even to assess whether such a maneuver is safe and/or appropriate.

In one or some embodiments, it may be essential that the autonomous agricultural production machine 3 is configured to sense anomaly data during and/or after the response routine (e.g., during and/or after execution of the response routine) and to transmit the anomaly data to a remote monitoring center 9 in a reporting routine, so that any one, any combination, or all of the following is performed: a user 10 may access the anomaly data in the remote monitoring center 9; the remote monitoring center 9 generates a control instruction for the autonomous agricultural production machine 3 (either fully automatically without input from the user 10 or based on user input from the user 10) to further respond to the anomaly; and the remote monitoring center 9 transmits the control instruction to the autonomous agricultural production machine 3; and that the autonomous agricultural production machine 3 automatically executes the control instruction and then automatically continues to perform the agricultural job.

In one or some embodiments, the remote monitoring center 9 comprises at least one computing device, such as a server sitting on the Internet. The remote monitoring center 9 may comprise at least one processor 14 and at least one memory 15 that stores information and/or software, with the processor configured to execute the software stored in the memory. Further, the remote monitoring center 9 may include a user interface 17 (e.g., a touchscreen) and a communication interface 18, which may be configured to communicate with one or more external electronic devices (e.g., autonomous agricultural production machine 3; autonomous agricultural universal production machine 4; etc.) wired and/or wirelessly. Thus, in one or some embodiments, the remote monitoring center 9 may comprise any type of computing functionality, such as the at least one processor 14 (which may comprise a microprocessor, controller, PLA, or the like) and the at least one memory 15. The memory 15 may comprise any type of storage device (e.g., any type of memory). Though the processor 14 and the memory 15 are depicted as separate elements, they may be part of a single machine, which includes a microprocessor (or other type of controller) and a memory. Alternatively, the processor 14 may rely on memory 15 for all of its memory needs.

The processor 14 and memory 15 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples. The above discussion regarding the at least one processor 14 and the at least one memory 15 may be applied to other devices, such as computing functionality that may be resident in any one, any combination, or all of: combine harvester 1, transport trailer 2; autonomous agricultural production machine 3; autonomous agricultural universal production machine 4; work assembly 5; forage harvester 6; rudimentary forage harvester 7; or AI model 11.

In principle, it is contemplated that a user 10 in the remote monitoring center 9 may access the anomaly data. Additionally or alternatively, artificial intelligence (AI), which may be manifested in AI model 11, may access the anomaly data and generate the control instruction (e.g., without any input from the user 10 so that the remote monitoring center 9 generates the control instruction fully automatically). The AI model 11 may be configured to perform one or both of the following: classifying; or controlling. In one or some embodiments, classifying may comprise identifying which of a set of categories (sub-populations) an observation (or observations) belongs to. In one or some embodiments, controlling may comprise determining, based on a classification, one or more actions to perform. Merely by way of example, responsive to identifying an obstacle (based on sensor input) and/or identifying a specific type of obstacle, the AI model 11 may be configured to perform a certain action (e.g., which may be manifested by the control instruction), thereby performing both classifying and controlling. Thus, the AI model may be based on a trained neural network (e.g., supervised and/or unsupervised learning) as the machine learning method.

The AI may transmit the control instruction directly to the autonomous agricultural production machine 3 or to the user 10 who may confirm or modify it. For example, at least one processor associated with AI model may access the anomaly data in a memory and generate/transmit the control instruction to the autonomous agricultural production machine 3. It is also contemplated that one set of anomalies may be handled by the user 10 (e.g., the user reviews the anomaly and determines the control instruction to send) and another set of anomalies may be handled by the AI. In this case, the AI may automatically decide, for example, using its processor and on the basis of security, whether the anomaly should be presented to a user 10. This may also make it possible to provide a higher performance AI in the remote monitoring center 9 than in the autonomous agricultural production machine 3.

This may allow the user 10 to decide how to respond to the anomaly. Continuing to perform the agricultural job is, of course, not envisaged in every case, but should be the goal usually sought. The remote monitoring center 9 may make it possible for the autonomous agricultural production machine 3 to perform the agricultural job without local monitoring, without its owner having to regularly check up on it or go out himself in case of anomalies, and without its owner finding an unfinished agricultural job in the evening.

Furthermore, in one or some embodiments, the monitoring using the remote monitoring center 9 may be enabled as a service (e.g., based on user input (e.g., via a touchscreen) indicative of a request by a user) using the autonomous agricultural production machine 3, such as via a terminal on or of the autonomous agricultural production machine 3. The autonomous agricultural production machine 3 may therefore be integrated as needed into the remote monitoring system as required without any hardware changes.

In one or some embodiments, the autonomous agricultural production machine 3 may perform an automatic emergency stop in the response routine. For example, the autonomous agricultural production machine 3 may, using its processor in executing the response routine, may determine to perform the automatic emergency stop and to control itself accordingly (e.g., control the drive resident on the autonomous agricultural production machine 3 to stop and/or control the work assembly 5 connected to the autonomous agricultural production machine 3 to stop). An emergency stop may comprise a stop of a travel movement and/or of a work assembly 5.

One example anomaly comprises an obstacle 8. Specifically, the autonomous agricultural production machine 3 may respond with the response routine to the obstacle 8. Since an autonomous agricultural production machine 3 should, in case of doubt, preferably detect a non-existing obstacle 8 than not detect an existing obstacle 8 (e.g., err on the side of false positive of detecting an obstacle 8), real and unreal obstacles 8 may occur regularly. At the same time, in any case previously unknown obstacles 8 in a field are more or less by definition unexpected, whereby it is to be expected that the agricultural production machine may occasionally be unable to respond to the obstacle 8. The remote monitoring center 9 may provide a simple remedy for this. In one or some embodiments, the control instruction is an instruction for automatically starting a predefined routine stored in the autonomous agricultural production machine 3, and/or that the user 10 and/or the AI remotely controls the autonomous agricultural production machine 3 using one or a plurality of control instructions, such as for avoiding the obstacle 8.

In one or some embodiments, the remote monitoring center 9 and the autonomous agricultural production machine 3 are configured such that the user 10 and/or the AI may use a predefined routine or remotely control the autonomous agricultural production machine 3 after the anomaly is present, such as depending on whether one of the predefined routines is adequate to respond to the anomaly according to the user's assessment.

In one or some embodiments, the remote monitoring center 9 is configured to automatically monitor a plurality of autonomous agricultural production machines 3 while the plurality of autonomous agricultural production machines 3 are performing a plurality of agricultural jobs, the plurality of autonomous agricultural production machines 3 automatically performs response routines and automatic reporting routines when anomalies occur, and the remote monitoring center 9 generates control instructions for the particular autonomous agricultural production machines 3 based on anomaly data from the plurality of autonomous agricultural production machines 3.

Therefore, for efficiency reasons, in one or some embodiments, the remote monitoring center 9 is configured to automatically monitor many autonomous agricultural production machines 3 of many farms and/or owners.

Further, in one or some embodiments, the autonomous agricultural production machines 3 perform the agricultural jobs automatically controlled by means of an AI model 11. In order to improve this AI model 11 over time, the anomaly data and the control instructions of the remote monitoring center 9 may be linked to form training data 12, and that the AI model 11 may be re-trained based on the linked training data 12. Additionally or alternatively, the AI in the remote monitoring center 9 may be re-trained in this way.

As a result, the autonomous agricultural production machine 3 therefore may automatically learn (e.g., indirectly learn), for example via software updates, from past reactions of the user 10 to anomalies, such as from a plurality of reactions when there are a plurality of anomalies that have occurred in a plurality of autonomous agricultural production machines 3.

This variant may become more interesting the greater the number of autonomous agricultural production machines 3 are monitored by the remote monitoring center 9.

In one or some embodiments, the autonomous agricultural production machine 3 is an autonomous agricultural universal production machine 4, or that the plurality of autonomous agricultural production machines 3 are autonomous agricultural universal production machines 4.

Each autonomous agricultural universal production machine 4 may be configurable to perform a plurality of different agricultural jobs by being equipped with alternate work assemblies 5.

In one or some embodiments, an autonomous agricultural universal production machine 4 is a production machine that may autonomously perform an agricultural job (e.g., without close user monitoring and automatically based on its own actions). In this case, the autonomous agricultural universal production machine 4 is an unmanned production machine. It may work by its itself or in a network.

Furthermore, the autonomous agricultural universal production machine 4 may be configured to perform a variety of different agricultural jobs, such as by replacing or attaching work assemblies 5.

In one or some embodiments, when the work assembly 5 is changed for an autonomous agricultural universal production machine 4, control assemblies concerning the work assembly 5 may additionally be changed, or control assemblies may be added. It is also contemplated that two (or more than two) autonomous agricultural universal production machines 4 jointly automatically operate a work assembly 5 (see FIG. 3), so that, for example, two autonomous agricultural universal production machines 4 together with a larger supporting structure with various work assemblies 5 function as a forage harvester 6, combine harvester 1, or something else.

In one or some embodiments, the autonomous agricultural universal production machine 4 or autonomous agricultural universal production machines 4 are individualized for their particular agricultural job by means of process knowledge. Such process knowledge may include any one, any combination, or all of: optimized settings of machine parameters; parameterizations of software modules; weightings by neural networks; a route plan; or an optimization strategy or the like. The specific process data may comprise, for example, field information data such as any one, any combination, or all of: a fruit type of a crop; a soil type; a soil slope; field-independent process data such as existing operating resources; or preceding and/or subsequent work steps. General process data may include non-specific process data such as optimized settings of the autonomous agricultural universal production machine 4 for a harvesting operation. Environmental data may be such data that do not directly affect the field but generally affects a larger environment, for example weather data, temperature data and the like. The process knowledge may be automatically used by the autonomous agricultural universal production machine 4 to perform the agricultural job; in particular, the autonomous agricultural universal production machine 4 may automatically use the process knowledge to set machine parameters.

In one or some embodiments, the process knowledge comprises work-assembly-specific work assembly knowledge 5 at least for some, or for all, work assemblies 5 with which the autonomous agricultural universal production machine 4 may be equipped. In this case, the autonomous agricultural universal production machine 4 need not have work assembly-specific work assembly knowledge 5 for some or all of the work assemblies 5 with which it may be equipped, at least in a basic or factory configuration. Alternatively, the autonomous agricultural universal production machine 4 may have work assembly type-specific work assembly knowledge 5 for some or all of the work assemblies 5 with which it may be equipped, at least in the basic or factory configuration. For example, the autonomous agricultural universal production machine 4 may have a basic set of plow-specific work assembly knowledge 5, but may be equipped by an external source for the individual agricultural job with work assembly knowledge 5 concerning the exact type of plow that allows more efficient use of the plow.

In one or some embodiments, therefore, the autonomous agricultural universal production machine 4 may be designed in such a way that it cannot use the particular work assembly 5 without the work-assembly-specific work assembly knowledge 5, or may use it only on the basis of the work-assembly-type-specific work-assembly knowledge 5.

In one or some embodiments, the machine parameters may be machine parameters in the narrow sense, such as the engine speed and/or a position of a choke valve. Also included may be settings of a rear power lift or the like. The machine parameters may also comprise instructions for setting automatic setting devices or other control systems of the autonomous agricultural universal production machine 4 from which machine parameters in the narrow sense are then generated.

In one or some embodiments, the user 10 and/or the AI in the remote monitoring center 9 has access to the process knowledge or a portion of the process knowledge.

In one or some embodiments, the anomaly data may comprise any one, any combination, or all of: environment data; machine data; a driving route; work assembly data of the autonomous agricultural production machine 3; or GPS data of the autonomous agricultural production machine 3.

Additionally or alternatively, the user 10 and/or the AI in the remote monitoring center 9 may access further data relating to any one, any combination, or all of: the agricultural job; the autonomous agricultural production machine 3; or the environment of the autonomous agricultural production machine 3 which may be stored in a database 13 of the remote monitoring center 9. Thus, in one or some embodiments, the further data may comprise environmental data (e.g., weather data) and/or field information data.

In one or some embodiments, the weather data and/or field information data may be provided to the remote monitoring center 9 by a farm management information system or the like.

Further, in one or some embodiments, the autonomous agricultural production machine 3 may continuously send data to the remote monitoring center 9 outside of the response routine while performing the agricultural job and/or may store data in a cloud, such as in the farm management information system, or that the autonomous agricultural production machine 3 only sends data to the remote monitoring center 9 responsive to the autonomous agricultural production machine 3 triggering the response routine.

In one or some embodiments, the user 10 and/or the AI in the remote monitoring center 9 may dispatch a local service technician when the anomaly is identified as a malfunction, and/or for the user 10 and/or the AI in the remote monitoring center 9 to dispatch a local service technician when a data connection with the autonomous agricultural production machine 3 is lost for at least a defined period of time.

In one or some embodiments, the remote monitoring center 9 may have a listing of service technicians for this purpose and, if necessary, know their workload. In one or some embodiments, the service technician closest to the field is typically involved. Prioritization (such as automatic prioritization by the remote monitoring center 9), for example, may be automatically performed according to the urgency or economic damage of the anomaly.

In one or some embodiments, the agricultural job is performed by a network of agricultural production machines, that at least one other agricultural production machine transmits environment sensor data to the remote monitoring center 9 after the autonomous agricultural production machine 3 has triggered the response routine, that the environment sensor data depict the autonomous agricultural production machine 3 and/or its immediate environment.

In one or some embodiments, a network may be understood to be a group of agricultural production machines cooperating and communicating with each other. If the sensor data of the autonomous agricultural production machine 3 is not sufficient to understand the anomaly, the user 10 and/or the AI in the remote monitoring center 9 may actively query environmental sensors from other agricultural production machines in the vicinity of the autonomous agricultural production machine 3 (e.g., the AI in the remote monitoring center 9 may automatically actively query environmental sensors from other agricultural production machines in the vicinity of the autonomous agricultural production). Alternatively, the environment sensor data may be automatically transmitted to the remote monitoring center 9, such as triggered by a communication automatically sent from the autonomous agricultural production machine 3 in the response routine to the network.

In one or some embodiments, the remote monitoring center 9 automatically monitors any one, any combination, or all of: the agricultural job; a preparation of the agricultural job; the approach of the agricultural job; or follow-up after the agricultural job was automatically performed.

In one or some embodiments, an autonomous agricultural production machine 3 may be configured for use in the disclosed method. Reference may be made to all statements regarding the proposed method.

In one or some embodiments, an autonomous agricultural production machine 3 may be used in the disclosed method. Reference may be made to all statements regarding the disclosed method.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Combine harvester
2 Transport trailer
3 Autonomous agricultural production machine
4 Universal production machine
5 Work assembly
6 Forage harvester
7 Rudimentary forage harvester
8 Obstacle
9 Remote monitoring center
10 User
11 AI model
12 Training data
13 Database
14 Processor
15 Memory
16 Computational functionality
17 User interface
18 Communication interface
19 Sensor

1. A method for monitoring one or more autonomous agricultural production machines, the method comprising;
autonomously performing, an autonomous agricultural production machine, an agricultural job;
detecting, by the autonomous agricultural production machine based on anomaly data sensed by the autonomous agricultural production machine, an anomaly;
executing, by the autonomous agricultural production machine, a response routine, wherein detecting the anomaly is one or both of during or after executing the response routine;
responsive to detecting an anomaly:
interrupting performance of the agricultural job;
transmitting, by the autonomous agricultural production machine, the anomaly data to a remote monitoring center;
generating, by the remote monitoring center based on the anomaly data, a control instruction;
transmitting, by the remote monitoring center, the control instruction to the autonomous agricultural production machine;
executing, by the autonomous agricultural production machine, the control instruction; and
resuming performance of the agricultural job.

2. The method of claim 1, further comprising:
inputting an instruction, via the autonomous agricultural production machine, indicating a request for enabling a service to be performed by the remote monitoring center to perform monitoring of the autonomous agricultural production machine;
transmitting the request from the autonomous agricultural production machine to the remote monitoring center; and
responsive to receiving the request, the remote monitoring center enables the service to perform the monitoring of the autonomous agricultural production machine.

3. The method of claim 1, wherein the autonomous agricultural production machine executing the response routine performs an emergency stop of the autonomous agricultural production machine.

4. The method of claim 1, wherein the anomaly comprises detecting an obstacle.

5. The method of claim 4, wherein the control instruction sent to the autonomous agricultural production machine is an instruction based on user input at the remote monitoring center in order to avoid the obstacle.

6. The method of claim 4, wherein the control instruction sent to the autonomous agricultural production machine is based on artificial intelligence (AI) at the remote monitoring center controlling the autonomous agricultural production machine in order to avoid the obstacle.

7. The method of claim 1, wherein the remote monitoring center monitors a plurality of autonomous agricultural production machines while performing a plurality of agricultural jobs;
wherein the plurality of autonomous agricultural production machines perform response routines and reporting routines when anomalies occur;
wherein the remote monitoring center generates control instructions for a respective autonomous agricultural production machines based on the anomaly data from one or more of the plurality of autonomous agricultural production machines.

8. The method of claim 7, wherein the plurality of autonomous agricultural production machines perform the agricultural jobs controlled by an artificial intelligence (AI) model;
wherein the anomaly data and the control instructions of the remote monitoring center (9) are linked to form training data;
and wherein the AI model is retrained based on the training data.

9. The method of claim 1, wherein the autonomous agricultural production machine comprises one or more autonomous agricultural universal production machines;
wherein each of the one or more autonomous agricultural universal production machines are configurable to perform a plurality of different agricultural jobs by being equipped with alternate work assemblies.

10. The method of claim 1, wherein the anomaly data comprise one or more of: environment data; machine data; a driving route; work assembly data of the autonomous agricultural production machine; or GPS data of the autonomous agricultural production machine.

11. The method of claim 1, wherein one or both of a user or artificial intelligence (AI) in the remote monitoring center accesses, from a database of the remote monitoring center, one or more of: data relating to the agricultural job; data relating to the autonomous agricultural production machine; or environment data of the autonomous agricultural production machine.

12. The method of claim 1, wherein the autonomous agricultural production machine transmits the anomaly data to the remote monitoring center responsive to executing the response routine.

13. The method of claim 1, further comprising identifying, to a user via the remote monitoring center and based on the anomaly data, that the anomaly is a malfunction of the autonomous agricultural production machine; and
responsive to identifying that the anomaly is a malfunction, soliciting user input; and
responsive to the user input, communicating with a service technician to fix the malfunction of the autonomous agricultural production machine.

14. The method of claim 1, wherein the agricultural job is performed by a plurality of agricultural production machines that are networked to communicate with one another;
wherein responsive to the autonomous agricultural production machine executing the response routine, the autonomous agricultural production machine sends a communication to at least one other agricultural production machine indicative of one or both of detecting an anomaly or executing the response routine; and
responsive to sending the communication, the at least one other agricultural production machine transmits environment sensor data to the remote monitoring center, wherein the environment sensor data depict one or both of: at least one aspect the autonomous agricultural production machine; or an immediate environment of the autonomous agricultural production machine.

15. The method of claim 1, wherein the remote monitoring center monitors: preparation for the agricultural job; approach of the autonomous agricultural production machine to the agricultural job; performance of the autonomous agricultural production machine of the agricultural job; and follow-up after the performance of the autonomous agricultural production machine of the agricultural job.

16. An autonomous agricultural production machine comprising:
a communication interface configured to communicate with a remote monitoring center;
at least one processor in communication with the communication interface and configured to:
autonomously perform an agricultural job;
detect, based on anomaly data sensed by the autonomous agricultural production machine, an anomaly;
execute a response routine, wherein detecting the anomaly is one or both of during or after executing the response routine;
responsive to detecting an anomaly:
interrupt performance of the agricultural job;
transmit, via the communication interface, the anomaly data to the remote monitoring center;
execute a response routine;
receive, from the remote monitoring center via the communication interface, a control instruction, the control instruction generated by the remote monitoring center based on the anomaly data;
execute the control instruction; and
resume performance of the agricultural job.

17. The autonomous agricultural production machine of claim 16, further comprising a user interface; and
wherein the at least one processor is further configured to
input an instruction, via the user interface, indicating a request for enabling a service to be performed by the remote monitoring center to perform monitoring of the autonomous agricultural production machine; and
transmit the request, via the communication interface, from the autonomous agricultural production machine to the remote monitoring center, wherein the request is indicative to the remote monitoring center to enable the service to perform the monitoring of the autonomous agricultural production machine.

18. The autonomous agricultural production machine of claim 16, wherein the at least one processor, in executing the response routine, is configured to perform an emergency stop of the autonomous agricultural production machine.

19. The autonomous agricultural production machine of claim 16, wherein the anomaly comprises detecting an obstacle.

20. The autonomous agricultural production machine of claim 19, wherein the control instruction received by the autonomous agricultural production machine is an instruction based on user input at the remote monitoring center in order to avoid the obstacle.
